(19) United States
(12) Patent Application Publication
(10) Pub. No.: US 2025/0377322 A1
(43) Pub. Date: Dec. 11, 2025

(54) DIFFERENTIAL SCANNING CALORIMETER

(71) Applicant: GM Global Technology Operations LLC, Detroit, MI (US)

(72) Inventors: Hernando Gonzalez Malabet, Livonia, MI (US); Artem Baskin, Rochester Hills, MI (US)

(21) Appl. No.: 18/735,709

(22) Filed: Jun. 6, 2024

(51) Int. Cl. G01N 25/48

(52) U.S. Cl. CPC G01N 25/4833; G01N 25/482

(57) ABSTRACT

A differential scanning calorimeter (DSC) includes a chamber containing a platform having at least a first reference material mount and a first sample material mount. A first calorimetric probe is configured to determine at least one thermochemical reaction of a first material in the first reference mount, and a second calorimetric probe is configured to determine at least one thermochemical reaction of a second material in the second reference mount. A rapid cooling system is at least partially disposed in the chamber. A controller is controllably coupled to at least the rapid heating system and the rapid cooling system. The controller is configured to rapidly heat the chamber and record the at least one thermochemical reaction of the second material as the second material temperature falls.

### INTRODUCTION

The subject disclosure relates to Differential Scanning calorimeter (DSC) tools, and more particularly to a DSC tool including an enhanced cooling system.

Differential scanning calorimetry is a thermoanalytical technique in which a difference in the amount of heat required to increase the temperature of a sample and a reference is measured as a function of temperature. Both the sample and reference are maintained at nearly the same temperature throughout the experiment. The key parameters of conventional experiments are the heating rate (in units of ° C./min) and the final temperature. Generally, the temperature program for a differential scanning calorimetry analysis is designed such that the sample holder temperature increases linearly as a function of time (i.e., constant heating rate). DSC spectra are measured for various heating rates, and the progression of the DSC spectroscopic features as a function of the heating rate provides information about the thermochemical reactions in the sample. The reference sample should have a well-defined heat capacity over the range of temperatures to be scanned. Additionally, the reference sample should be stable, of high purity, and must not experience much change across the temperature scan. Typically, reference standards have been metals such as indium, tin, bismuth, and lead, but other standards such as polyethylene and fatty acids have been proposed to study polymers and organic compounds, respectively.

Differential Scanning calorimeters (DSC's) are tools used to perform a differential scanning calorimetry experiment. Existing DSC's are constructed using hardware components that enable heating of materials at various rates and sensors to measure the power of heat required to reach pre-defined temperatures (follow a heating protocol). The variations (aka peaks in DSC spectra) of the heat power at various temperatures are usually associated with individual thermochemical reactions that may have different time scales and exo/endo-thermic effects. It is usually unclear if each DSC peak corresponds to one or multiple overlapping thermochemical reactions. To resolve the DSC spectra the fast cooling is needed in addition to the conventional heating, and the faster the cooling rate is applied, the higher the resolution of the DSC spectra can be achieved. However, current DSC's are not configured to provide active cooling at sufficient rates to perform cooling experiments. The maximum achievable cooling rate of conventional systems is about 80 C per minute.

As such, it is desirable to provide a DSC including the capability to perform both controlled and fast heating and faster cooling operations.

### SUMMARY

In one exemplary embodiment a differential scanning calorimeter (DSC) includes a chamber containing a platform having at least a first reference material mount and a first sample material mount. A first calorimetric probe is configured to determine at least one thermochemical reaction of a first material in the first reference mount, and a second calorimetric probe is configured to determine at least one thermochemical reaction of a second material in the second reference mount. A rapid cooling system is at least partially disposed in the chamber. A controller is controllably coupled to at least the rapid heating system and the rapid cooling system. The controller is configured to rapidly heat the chamber and record the at least one thermochemical reaction of the second material as the second material temperature falls.

In addition to one or more of the features described herein the rapid cooling system includes a fluid cooler disposed immediately below, and in thermal communication with, the platform.

In addition to one or more of the features described herein the fluid cooler contains a water based coolant and wherein the water based coolant has less than 20% water.

In addition to one or more of the features described herein the water based coolant is a combination of water and ethylene glycol.

In addition to one or more of the features described herein the water based coolant is between 80% and 90% a non-water coolant, and wherein the non-water coolant is one of ethylene glycol and propylene glycol.

In addition to one or more of the features described herein the controller is configured to cause cooling fluid to pulse through the fluid cooler during a rapid cooling process.

In addition to one or more of the features described herein the rapid cooling system includes a semiconductor cooler and a convective air cooler.

In addition to one or more of the features described herein the semiconductor cooler includes a thermoelectric cooler disposed immediately adjacent, and in thermal communication with, the platform, the semiconductor cooler includes a first surface contacting the second platform, and a second surface opposite the first surface, a heat sump channel extending outward from the second surface and into a cooling air flow, and a fan configured to generate the cooling air flow.

In addition to one or more of the features described herein the semiconductor cooler is a Peltier cooler.

In addition to one or more of the features described herein the semiconductor cooler includes a first positive current lead and a first negative current lead and wherein the semiconductor cooler is active when current is applied across the first positive current lead and the first negative current lead, and wherein the fan includes a second positive current lead and a second negative current lead and wherein the fan is on when current is applied across the second positive current lead and the second negative current lead, and wherein the controller includes a cooling system positive control current lead and a cooling system negative control current lead, and wherein each of the first negative current lead and the second negative current lead are connected to the cooling system negative control current lead and each of the first positive current lead and second positive current lead are connected to the cooling system positive control current lead.

In addition to one or more of the features described herein the heat sump channel is a thermally conducive rod.

In addition to one or more of the features described herein at least one thermochemical reaction of the second material is a specific heat flux.

In another exemplary embodiment a method for measuring at least one thermoelectric property of a first material includes placing a reference material in a reference material mount of a differential scanning calorimeter (DSC) and placing the first material in a sample material mount, lowering the temperature of the DSC at a rate of at least 80° C. per minute using a rapid cooler until a second target temperature is reached, and measuring the thermochemical reaction of the sample material as the temperature of the DSC is lowered, and synthesizing the measured thermochemical reactions of the sample material into a single output chart using a controller.

In addition to one or more of the features described herein lowering the temperature of the DSC includes activating a semiconductor cooler and an airflow fan.

In addition to one or more of the features described herein the semiconductor cooler and the airflow fan are operated simultaneously.

In addition to one or more of the features described herein a cooler controller outputs a single control signal to both the semiconductor cooler and the airflow fan.

In addition to one or more of the features described herein lowering the temperature of the DSC includes pulsing a coolant through a fluid cooler using a fluid pump, and wherein the coolant is a water based coolant have less than 20% water.

In addition to one or more of the features described herein the water based coolant is a combination water and Ethelyne Glycol.

In addition to one or more of the features described herein a percentage of water in the water based coolant is a minimum percentage of water pumpable by the fluid pump.

In addition to one or more of the features described herein lowering the temperature of the DSC at a rate of at least 80° C. per minute, comprises lowering the temperature at a rate of 160° C. per minute.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic representation of a differential scanning calorimeter (DSC);

FIG. 2A depicts a hypothetical thermomechanical reaction performed using conventional DSC cooling;

FIG. 2B depicts the hypothetical thermomechanical reaction of FIG. 2A performed using a controlled rapid heating and cooling system of the DSC of FIG. 1;

FIG. 3 depicts a process of the DSC of FIG. 1;

FIG. 4 depicts an exemplary implementation of the DSC of FIG. 1; and

FIG. 5 depicts another exemplary implementation of the DSC of FIG. 1.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As used herein, “rapid heating” and “rapid cooling” refers to a heating or cooling process that induces temperature changes at a rate of at least 80° C. per minute. In some examples, the rate of change can be an increase or decrease of at least 100° C. per minute. In yet further examples, the rate of change can include an increase or decrease of approximately 160° C. per minute.

In accordance with an exemplary embodiment methods, devices and systems are provided for implementing a controlled cooling system within a differential scanning calorimeter (DSC) tool. The controlled cooling system is configured to increase a rate of cooling using either, or both, of a fast liquid cooling control scheme and a combination primary cooler and a semiconductor cooler (e.g., a Peltier device).

Embodiments described herein present numerous advantages and technical effects. Included among the advantages and technical effects is an ability to rapidly cool a sample at rates of up to 120° C. per minute as well as providing cooling to a targeted temperature allowing for more controlled experiments. Some thermochemical reactions may become ascertainable during a cooling process, but not a heating process, and thus cannot determined during differential scanning calorimetry experiments using existing DSC's.

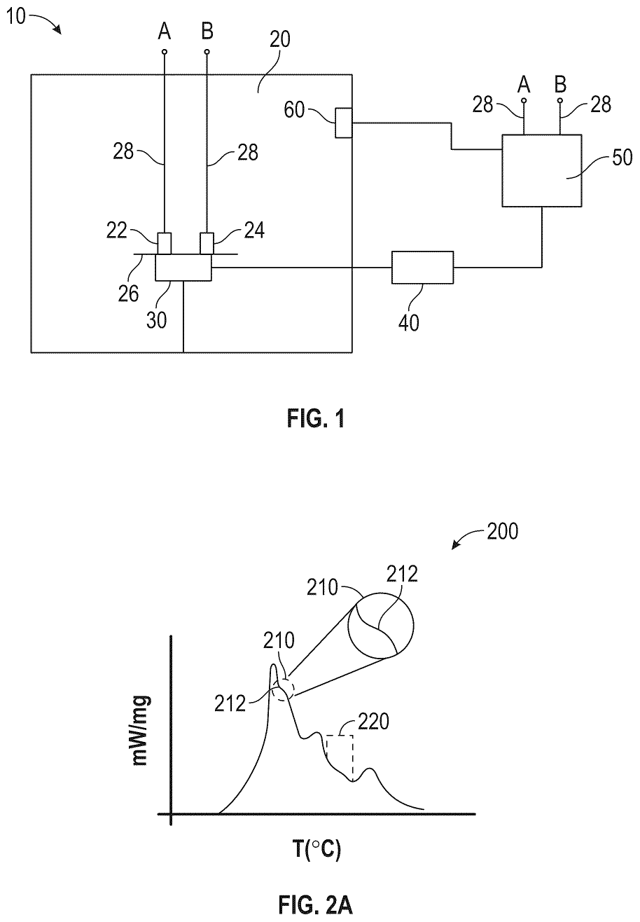

FIG. 1 illustrates an exemplary DSC 10 including a chamber 20. Within the chamber 20 is a reference material mount 22 and a sample material mount 24 (collectively referred to as material mounts 22, 24). Connected to each material mount 22, 24 is a corresponding calorimetric probe 28 with each calorimetric probe 28 being in communication with a controller 50 such that the calorimetric probes 28 communicate at least a temperature measurement of the material in the material mount 22, 24 to the controller 50. In some examples, the calorimetric probe 28 are able to measure and communicate one or more additional thermochemical properties of the materials in the material mounts 22, 24 to the controller 50. The material mounts 22, 24 are situated on a platform 26, under which is a cooling system component 30. The cooling system component 30 is interconnected with a cooling system 40 and can be an electric cooler, a liquid cooling component, or any other cooler able to achieve rapid cooling of the chamber 20 in which the material mounts 22, 24 are located.

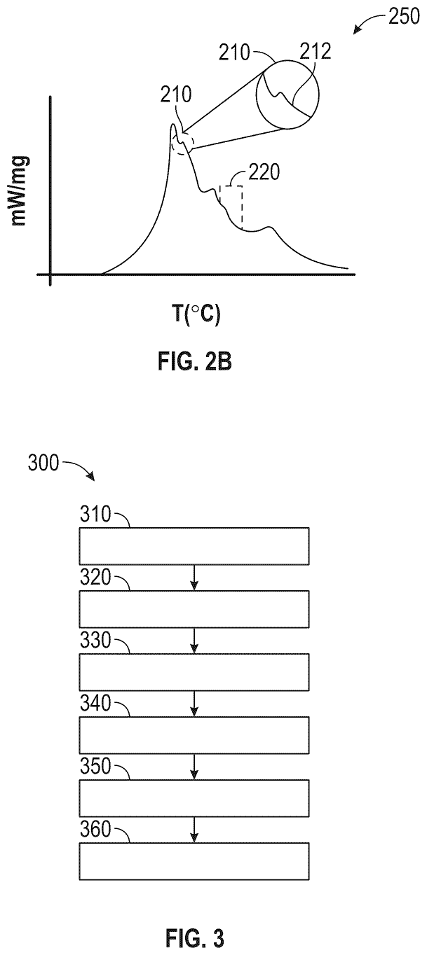

The controller 50 is connected to the cooling system 40 and a heating system 60. The heating system 60 can be any known heating system type and is controlled via the controller 50 using known control techniques to raise a temperature within the chamber 20 to a target temperature. Due to the temperature in the chamber, 20, the temperatures of the materials in the material mounts 22, 24 rise or fall, and the thermochemical properties of the materials can be monitored. The controller 50 further controls the cooling system 40 according to a process 200 (illustrated in FIG. 2), with the process providing rapid targeted cooling to specific temperatures and to provide controlled cooling rates.

With continued reference to the DSC 10 of FIG. 1, FIG. 2A illustrates a chart 200 demonstrating a specific heat flux (mW/mg) with respect to temperature T(° C.) of a hypothetical material as seen by existing DSC's. The existing DSC's measure the thermochemical reactions of the materials during a rapid heating process. After the rapid heating process, the sample is cooled using conventional cooling processes. Once cooled to a low enough temperature for handling, the materials are removed from the chamber 20, and the next experiment can be run. The specific heat flux shown in the chart 200 includes a first region 210 illustrating a downward, but changing, slope of the specific heat flux. Additionally, at region 220 the specific heat flux appears to be a smooth curve.

By contrast, FIG. 2B illustrates a chart 250 demonstrating a specific heat flux (mW/mg) with respect to temperature T(° C) of the same hypothetical material as measured by the DSC 10 of FIG. 1, which measures the thermomechanical reactions during both a rapid heating process and the rapid cooling process. By monitoring the thermomechanical reactions during a controlled rapid cooling process, as well as during a controlled rapid heating process, additional fidelity of the chart 250 is provided. Similar additional fidelity can be determined for any thermochemical reaction being measured, and the specific heat flux is exemplary in nature.

In particular at region 210, what appears to be only a smooth downward slope as the chart 200 progresses to higher temperatures (FIG. 2A) resolves to a localized valley and peak on the chart 250 when measured during the rapid cooling process as well as the rapid heating process (FIG. 2B).

Similarly, what appears as a smooth slope transition across region 220 when measured during heating resolves to downward transition having a slope that consistently changes (e.g., the downward slope change appears smooth). Whereas, when measured across both rapid heating and cooling (FIG. 2B), the change in slope is not consistent (e.g., the downward slope appears ‘rough’).

The illustrated additional resolution provided by the controlled rapid heating and cooling demonstrated in the chart 250 of FIG. 2B is exemplary and hypothetical. Practical uses of the rapid heating and rapid cooling of the DSC 10 of FIG. 1 will demonstrate any number of similar additional peaks, valleys, and disturbances depending on the particular material and thermochemical reaction being measured. This allows for additional thermochemical reactions to be identified and resolved.

With continued regards to FIGS. 1, 2A, and 2B, FIG. 3 illustrates a process 300 for operating the DSC 10 of FIG. 1. Initially the controller 50 rapidly increases the heat within the chamber 20 to a target high temperature (Th) using the heating system 60 in a Heat Sample to Th step 310. As the chamber 20 temperature is increased to the target temperature, the calorimetric probes 28 provide measurements of both the reference material (via probe 28 A) and the sample material (via probe 28 B) being tested to the controller 60. The measurements are recorded in a first Record Measurements step 320.

Once the materials have reached the target temperature, the controller 50 uses the cooling system 40 to rapidly decrease the temperature of the chamber 20 to a low temperature target T1 in a Rapid Cool Sample to T1 step 330. As the chamber 20 temperature is decreased to the target low temperature, the calorimetric probes 28 provide measurements of both the reference material (via probe 28 A) and the sample material (via probe 28 B) being tested to the controller 60. The measurements are recorded in a second Record Measurements step 340.

Once both sets of measurements have been recorded, the outputs from the heat flow and temperature sensors are translated and transduced into calibrated temperature and heat flux values at a user defined acquisition rate (seconds) in a Combine Data Step 350. The datapoints are then plotted as portrayed in FIG. 2A, 2B and the chart 250 is output for analysis at an Output Chart step 360.

The measurements are combined and synthesized by the controller 50 into a single thermochemical property chart (i.e., the chart 250 of FIG. 2B) in a Combine Data Step 350, and the chart 250 is output for analysis at an Output Chart step 360.

In addition to the additional resolution provided by the rapid cooling measurements, the use of a rapid cooling process allows samples to be tested more quickly increasing the number of tests that can be performed in a shortened time period.

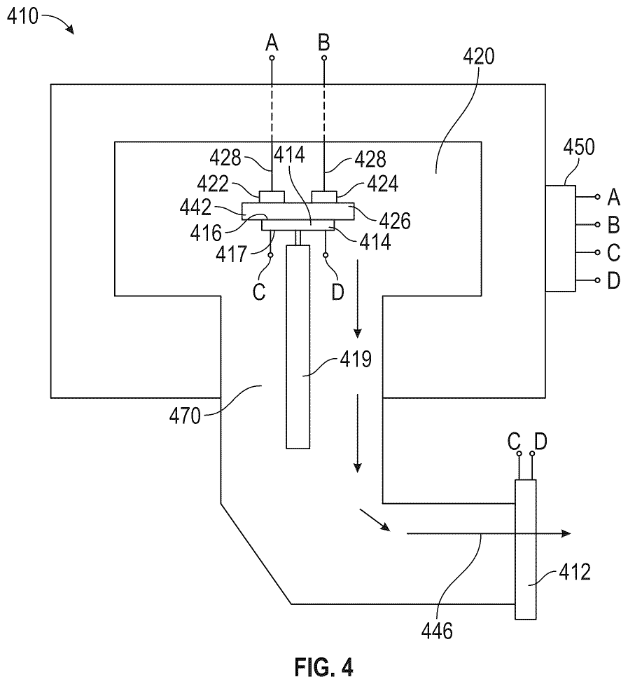

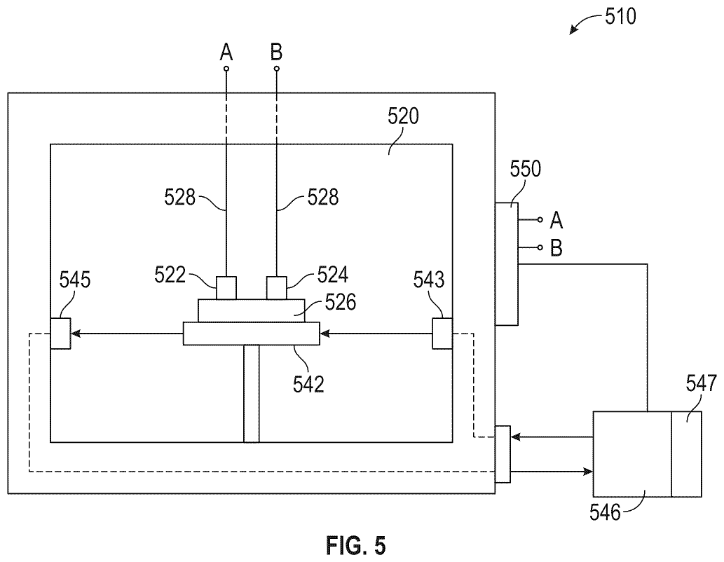

The DSC 10 includes one, or a combination of, rapid cooling systems including a rapid liquid cooling system and/or a combined air cooling and semiconductor cooler cooling system. FIG. 4 illustrates an example DSC 410 using a combination of air cooling via a fan 412 or compressed air and semiconductor cooling via a semiconductor based thermoelectric cooler 414 (e.g. a Peltier device) to achieve the rapid cooling. FIG. 5 illustrates an example DSC 510 using a water based cooling system to achieve the rapid cooling. While illustrated separately for ease of explanation, in alternative examples, the air/thermoelectric cooling system of FIG. 4 and the water cooling system of FIG. 5 could be used together in a single implementation thereby achieving even more rapid cooling.

With reference now to FIG. 4, the DSC 410 includes a chamber 420. Within the chamber 420 is a reference material mount 422 and a sample material mount 424 (collectively referred to as mounts 422, 424). Connected to each material mount 422, 424 is a corresponding calorimetric probe 428 with each calorimetric probe 428 being in communication with a controller 450 such that the calorimetric probes 428 communicate a temperature measurement of the material in the corresponding material mount 422, 424 to the controller 450. The material mounts 422, 424 are situated on a platform 426, under which is a thermoelectric cooler 414. The thermoelectric cooler 414 is a semiconductor including a positive lead C and a negative lead D. As current is applied to the leads C, D, and passes through the thermoelectric cooler 414, a first surface 416 of the thermoelectric cooler 414 is near freezing temperatures and a second surface 417 of the thermoelectric cooler 414 is at an offsetting high temperature.

The thermoelectric cooler 414 is positioned with the first surface 416 in contact with a thermally conductive plate 426 that thermally connects the thermoelectric cooler 414 to the material mounts 422, 424, thereby cooling the materials positioned in the material mounts 422, 424. A thermally conductive heat sump channel 419 provides a thermal conduit from the hot side 417 of the thermoelectric cooler 414 to an airflow passageway 470. In one example the heat sump channel 419 is a thermally conductive rod, such as copper rod. In other examples, any other similarly thermally conductive material able to withstand the temperatures inside the chamber 420 may be used as well.

In addition to the thermoelectric cooling provided by the thermoelectric cooler 414, the DSC 410 includes a fan 412 (or set of fans working cooperatively) to drive an airflow 446 through the chamber 420. The airflow 446 provides convective cooling to the materials in the material mounts 424. The fan 412 is controlled via application of a control current from the controller 450 to a positive terminal C and a negative terminal D. As the thermoelectric cooler 414 and the fans 412 utilize the same control current and the controller 450 outputs control signals to terminals C and D, and the control signal is provided to both the thermoelectric cooler 414 and to the fan 412. This in turn causes both cooling devices in the cooling system of FIG. 4 to be driven simultaneously.

With reference to FIG. 5, the DSC 510 includes a chamber 520. Within the chamber 520 is a reference material mount 522 and a sample material mount 524 (collectively referred to as material mounts 522, 524). Connected to each material mount 522, 524 is a corresponding calorimetric probe 528 with each calorimetric probe 528 being in communication with a controller 550 such that the calorimetric probes 528 communicate a temperature measurement of the material in the corresponding material mount 522, 524 to the controller 550. The material mounts 522, 524 are situated on a platform 526, under which is a liquid cooler 542. The liquid cooler 542 is configured to receive a cooled liquid from a first port 543, pass the cooled liquid through the liquid cooler 542 and output the cooled liquid through a second port 545. The cooled liquid is driven along this flowpath via a cooling fluid pump 546 and stored in a fluid reservoir 547. While outside the chamber 520, the cooled liquid is cooled and returned to the coolant loop via any known cooling system.

The platform 526 is thermally conductive, and heat from the materials in the material mounts 522, 524 is passed to the cooling fluid in the liquid cooler 542. By cicrulating the cooling fluid out, the heat is removed.

The pump 546 is controlled via a controller 550, which utilizes a pulsing operation to move a volume of fluid into the liquid cooler 542. The fluid is allowed to remain in the liquid cooler 542 and heat is transferred to the fluid through the plate 542. The pump then pulses again driving a new volume of cooled fluid to replace the fluid in the liquid cooler 542, and the cycle iterates allowing for a fast and controlled cooling.

Existing liquid cooling systems usually utilize a mixture of coolants and water, with the mixture having about 50% water and 50% coolant. The water to coolant ratio is selected to ensure the viscosity of the combined water and coolant is low enough that the pump 546 has no difficulty moving the fluid through the cooling system 540.

In order to further increase the rate of cooling provided by the liquid cooler 542, the cooling fluid incorporated in the DSC 510 of FIG. 5 is a mixture of water and Ethylene or Propylene Glycol, with the mixture being limited to between 10% and 20% water with the particular percentage of water being the smallest percentage at which the pump 546 can drive the fluid without damaging the pump 546. This results in a substantially more viscous fluid than existing systems with much higher thermal capacity. The higher thermal capacity, in turn, allows more heat to be removed on each pulse, further increasing the rate of cooling applied.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A differential scanning calorimeter (DSC) comprising:
a chamber containing a platform having at least a first reference material mount and a first sample material mount;
a first calorimetric probe configured to determine at least one thermochemical reaction of a first material in the first reference material mount, and a second calorimetric probe configured to determine at least one thermochemical property of a second material in the second reference material mount;
a rapid cooling system at least partially disposed in the chamber; and
a controller controllably coupled to at least the rapid heating system and the rapid cooling system, the controller being configured to rapidly cool the chamber and record the at least one thermochemical property of the second material as the temperature of the second material falls.

2. The DSC of claim 1, wherein the rapid cooling system includes a fluid cooler disposed immediately below, and in thermal communication with, the platform.

3. The DSC of claim 2, wherein the fluid cooler contains a water based coolant and wherein the water based coolant has less than 20% water.

4. The DSC of claim 3, wherein the water based coolant is a combination of water and ethylene glycol.

5. The DSC of claim 4, wherein the water based coolant is between 80% and 90% a non-water coolant, and wherein the non-water coolant is one of ethylene glycol and propylene glycol.

6. The DSC of claim 3, wherein the controller is configured to cause cooling fluid to pulse through the fluid cooler during a rapid cooling process.

7. The DSC of claim 1, wherein the rapid cooling system includes a semiconductor cooler and a convective air cooler.

8. The DSC of claim 7, wherein the semiconductor cooler includes a thermoelectric cooler disposed immediately adjacent, and in thermal communication with, the platform;
wherein the semiconductor cooler includes a first surface contacting the platform, and a second surface opposite the first surface;
a heat sump channel extending outward from the second surface and into a cooling air flow; and
a fan configured to generate the cooling air flow.

9. The DSC of claim 8, wherein the semiconductor cooler is a Peltier cooler.

10. The DSC of claim 8, wherein the semiconductor cooler includes a first positive current lead and a first negative current lead and wherein the semiconductor cooler is active when current is applied across the first positive current lead and the first negative current lead, and wherein the fan includes a second positive current lead and a second negative current lead and wherein the fan is on when current is applied across the second positive current lead and the second negative current lead, and wherein the controller includes a cooling system positive control current lead and a cooling system negative control current lead, and wherein each of the first negative current lead and the second negative current lead are connected to the cooling system negative control current lead and each of the first positive current lead and second positive current lead are connected to the cooling system positive control current lead.

11. The DSC of claim 8, wherein the heat sump channel is a thermally conducive rod.

12. The DSC of claim 1, wherein at least one thermochemical reaction of the second material is a specific heat flux.

13. A method for measuring at least one thermoelectric property of a first material comprising:
placing a reference material in a reference material mount of a differential scanning calorimeter (DSC) and placing the first material in a sample material mount;
lowering a temperature of the DSC at a rate of at least 80° C. per minute using a rapid cooler until a second target temperature is reached, and measuring the thermochemical reaction of the first material as the temperature of the DSC is lowered; and
synthesizing the measured thermochemical reactions of the first material into a single output chart using a controller.

14. The method of claim 13, wherein lowering the temperature of the DSC includes activating a semiconductor cooler and an airflow fan.

15. The method of claim 14, wherein the semiconductor cooler and the airflow fan are operated simultaneously.

16. The method of claim 15, wherein a cooler controller outputs a single control signal to both the semiconductor cooler and the airflow fan.

17. The method of claim 13, wherein lowering the temperature of the DSC includes pulsing a coolant through a fluid cooler using a fluid pump, and wherein the coolant is a water based coolant have less than 20% water.

18. The method of claim 17, wherein the water based coolant is a combination water and Ethelyne Glycol.

19. The method of claim 18, wherein a percentage of water in the water based coolant is a minimum percentage of water pumpable by the fluid pump.

20. The method of claim 13, wherein lowering the temperature of the DSC at a rate of at least 80° C. per minute, comprises lowering the temperature at a rate of 160° C. per minute.
